(19) United States
(12) Patent Application Publication
(10) Pub. No.: US 2009/0135736 A1
(43) Pub. Date: May 28, 2009

(54) Method of connecting network terminal devices of a private network by using a hand-held electronic device

(75) Inventors: Yi-Hsiang Lin, Taipei City (TW); You-Hsin Yen, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 12/007,408

(22) Filed: Jan. 10, 2008

(30) Foreign Application Priority Data
Nov. 22, 2007 (TW) 096144218

(51) Int. Cl. H04L 12/28

(52) U.S. Cl. 370/254

(57) ABSTRACT

The present invention is to provide a method applied to a network system which comprises a private network having at least a computer and at least two network terminal devices connecting to the Internet, and said computer is installed with a Fat UA while said hand-held electronic device is installed with a Thin User Agent enabling said hand-held electronic device to send a control command to said computer through the Internet. After said control command is received, said Fat UA encapsulates said control command in two SIP packets for connection request and connection response and send them to said two network terminal devices respectively. And after said SIP packets are received, said network terminal devices will send the SIP packets with each other so as to automatically establish a tunnel and proceed mutual data access therebetween according to said control command encapsulated in said SIP packets.

### FIELD OF THE INVENTION

The invention relates to a user agent (hereinafter abbreviated as “UA”), more particularly to a thin user agent (hereinafter abbreviated as “Thin UA”) installed in a hand-held electronic device for establishing a tunnel between two network terminal devices of a remote private network via the Internet and enabling the network terminal devices to proceed mutual data access therebetween.

### BACKGROUND OF THE INVENTION

Recently, as the computer and network technologies quickly evolve, digital electronic devices like computers, electrical household appliances and network terminal devices (such as web camera, IP phone, web disk and network printer etc.) are getting cheaper and more compact and have been widely used in people's daily life and work. Take digital electronic device for example, there is a large amount of data stored in a digital camera, recorder, DVD-Player, Set-Top-Box, MP3-Player and computer etc., however, the exchange of said digital data is unavailable for that the interfaces and data formats of said devices are different from each other. To solve the problem stated above, the MICROSOFT corporation has applied the technology of Plug and Play under the stand-alone environment to the network environment and developed a Universal Plug and Play (UPnP for short) protocol. The UPnP protocol is a device protocol for digital home and with the main purpose of easy setup, operation and management of all kinds of digital electronic devices where all setup of a device may be completed through the UPnP protocol and what the user has to do is connecting the device and the network line and turning on the power, then the device may join a private network dynamically, acquire its IP address, announce its name, provide services according to demands and recognize the existence and function of other device in the private network. Besides, through the UPnP protocol, the device may be disconnected from the private network automatically and smoothly without leaving any problem. For the reason of independence from specific operating system, programming language or physical media, the UPnP protocol enables each device of a small private network like a home network or small network of a enterprise or a domestic/commercial building to be accessed by other computer, application or intelligent device and become a terminal device thus makes the UPnP protocol an important frame, protocol and interface standard for all kinds of computers, network terminal devices, applications or intelligent devices.

In addition, accompanying the newer vision of operating system WINDOWS VISTA, the MICROSOFT also has developed a WINDOWS RALLY technology for improving mutual communication between network terminal devices which accomplishes easy discovery, allocation and connection between network terminal devices in a private network and enables a network terminal device to connect with other device and share the functions provided which meets the urgent need of real-time access of a hand-held digital electronic device nowadays and is expected to establish a bridge with high flexibility between all kinds of digital electronic devices. To achieved the objectives of easy connection and unified communication between digital electronic devices, the MICROSOFT and other international corporations like INTEL and W3C etc. have together proposed a new standard of DEVICE PROFILE FOR WEB SERVICES (DPWS) and related WEB SERVICES (WS) protocol system to make the connection between the following categories of digital electronic devices easier and mutual communication more reliable:
(1) computer and input/output device, such as a personal computer, keyboard, game device, scanner, printer and projector etc.;
(2) storage device, such as a hard disk, DVD, SD, CD etc.;
(3) network connection device, such as a router, gateway, AP etc.;
(4) media device, such as a MP3 player, audio device, DVR etc.; and
(5) household appliance, such as a telephone, intelligent illuminator, air conditioning system etc.

Within the frame of WINDOWS RALLY, there is a Plug and Play Extensions (PnP-X) protocol for enabling automatic discovery between said digital electronic devices on the computer and making said devices to be used just like a digital electronic device plugged into a USB interface. And in the application program interfaces (API for short) embedded in the operating system WINDOWS VISTA, there are also some new APIs which support WINDOWS RALLY and enrich user experience as well wherein the Function Discovery (FD) API is the implementation of DPWS on WINDOWS VISTA and supports Simple Service Discovery Protocol (SSDP) and WS-Discovery (WS-D). The FD API mainly comprises APIs of WS-D and UPnP AV wherein WS-D aims at network terminal device over the Internet and provides solutions for enterprises while UPnP AV targets at audio/video digital electronic devices of home networks.

However, to allow a computer to discover said digital electronic devices automatically, its operating system is required to equip with complicated Session Initiation Protocol (SIP) function stacks and related APIs which will be mentioned as a Fat User Agent (hereinafter abbreviated as “Fat UA”) hereinafter. And due to that the Fat UA occupies quite a few memory space (2 to 3 Mega bytes at least) and consumes considerable CPU resource and temporary memory space while running, for certain compact hand-held electronic devices (such as hand-held wireless communication devices like mobile phones or personal digital assistants etc.) with limited memory space and fair processor performance, it's infeasible to install the Fat UA thus the functions of automatic discovery and operation of said digital electronic devices couldn't be realized.

Hence, to develop a network system which enables said hand-held electronic device to establish a tunnel between two network terminal devices of a remote private network through the Internet for mutual data access has become an important objective to be achieved.

### SUMMARY OF THE INVENTION

For the purpose of solving the problems stated above, after hard work of research and experiments for a long time, the inventor has developed a method of connecting network terminal devices of a private network by using a hand-held electronic device of the present invention which enables a hand-held electronic device to establish a tunnel between two network terminal devices of a private network through the Internet and enables the network terminal devices to proceed mutual data access therebetween.

The objective of the present invention is to provide a method of connecting network terminal devices of a private network by using a hand-held electronic device applied to a network system which comprises a private network, a hand-held electronic device (such as a hand-held wireless communication device like a mobile phone or personal digital assistant etc.) and the Internet wherein said private network comprises at least a computer with network interface (such as a personal computer or server etc.) and at least two network terminal devices (such as web camera, IP phone, web disk or network printer etc.) which all connect to the Internet through a network connection device (such as a router or switch), and said computer is installed with a Fat UA while said hand-held electronic device is installed with a Thin User Agent (hereinafter abbreviated as “Thin UA”) which is capable of processing simple commands and establishing network connection to receive, transfer and process the commands and enable said hand-held electronic device to connect with said computer and send a control command to said computer through the Internet. After said control command is received, said Fat UA encapsulates said control command in two SIP packets and send them to said two network terminal devices respectively. And after said SIP packets are received respectively, a SIP packet for connection request and a SIP packet for connection response will be sent by said network terminal devices with each other so as to automatically establish a tunnel between said network terminal devices and enable said network terminal devices to proceed mutual data access therebetween according to said control command encapsulated in said SIP packets.

### BRIEF DESCRIPTION OF THE DRAWINGS

The foregoing aspects, as well as many of the attendant advantages and features of the present invention will become more apparent by reference to the following detailed description, when taken in conjunction with the accompanying drawings, wherein:

FIG. 1 shows the structure of a network system of a preferred embodiment of the present invention;

FIG. 2 is a flow chart of a preferred embodiment of the present invention; and

FIG. 3 shows the sequences of establishing a tunnel according to the process shown in FIG. 2.

### DETAILED DESCRIPTION OF THE PREFERRED EMBODIMENT

The SIP is developed by the INTERNET ENGINEERING TASK FORCE (IETF) MULTI-PARTY MULTI-MEDIA SESSION CONTROL (MMUSIC) working group for establishing, modifying and terminating various interactive user sessions which comprise multimedia interactive sessions like video, audio, real-time communication and online game. Like H.323, the SIP is primarily used in Voice over Internet Protocol (VoIP) and with the objective of providing extensions similar with call processing functions in PUBLIC SWITCHED TELEPHONE NETWORK (PSTN) to implement functions like providing dial tone, ring tone, ring-back tone, busy tone etc. while with different implementation and terms. Generally speaking, the SIP is a peer-to-peer protocol applied to a relatively simple core network and allows intelligent terminals (such as network terminal devices with hardware or software) on the edge of the network to handle the processing thus various functions of the SIP are carried out at the terminals which is much different from the conventional PSTN that handles the processing by using its core network devices. The SIP is based on the IP network system and may work together with many other protocols to deal with signals related to communication session wherein the Session Description protocol (SDP) information embedded in the SIP packets describes the data stream of the session such as which IP port is used or which codec is adopted and so on. The Real-time Transport Protocol (RTP) is the actual carrier of the audio or video data stream that it may not pass through a NAT router easily, however, most SIP users may pass through NAT routers with the help of Simple Traversal of UDP over NAT (STUN) or use RTP proxy server to pass through traditional NAT router that can't recognize the SIP.

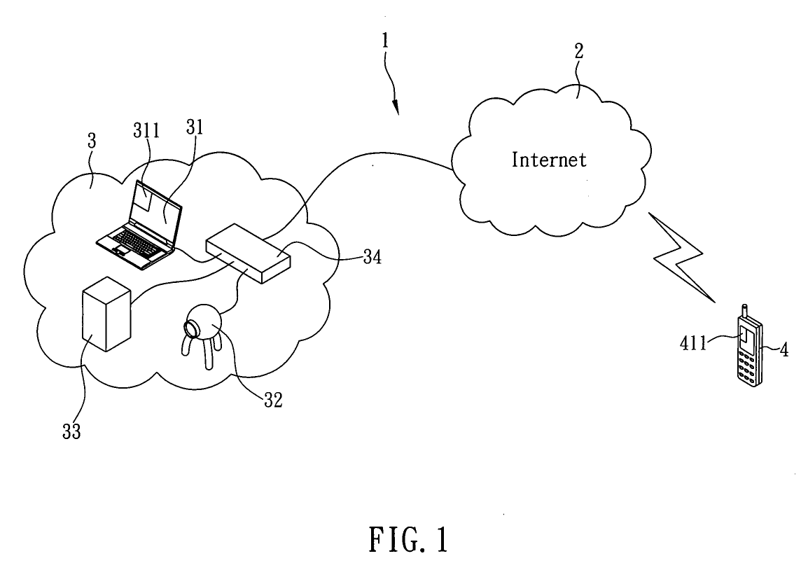

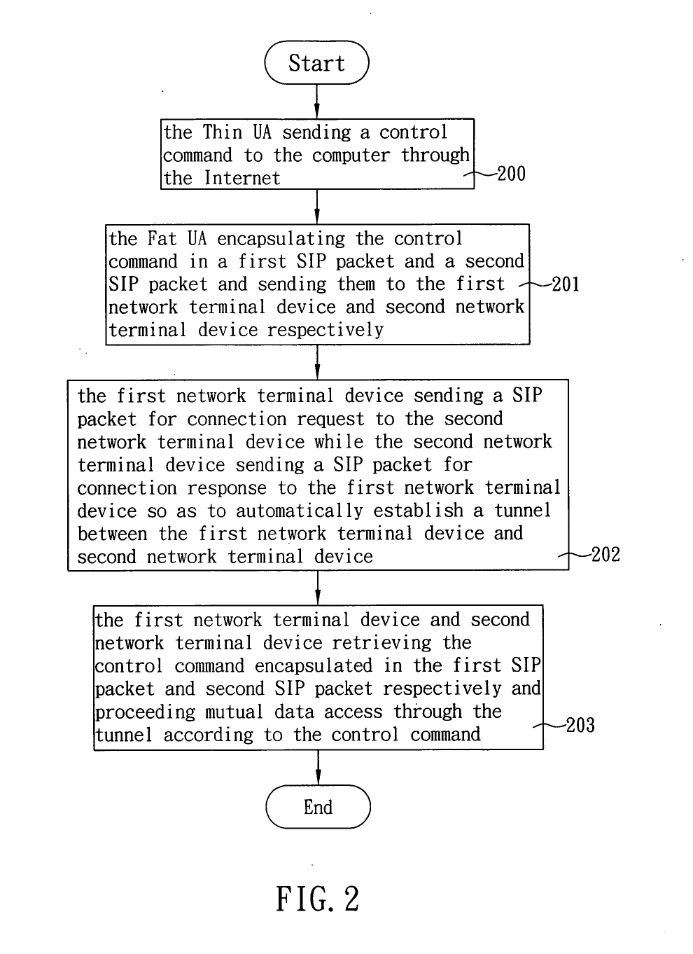

According to above principles of the SIP, the inventor has developed a method of connecting network terminal devices of a private network by using a hand-held electronic device which enables a hand-held electronic device to establish a tunnel for mutual data access between two network terminal devices connected with a computer of a remote private network by using a user agent installed on the computer according to the SIP. Please refer to FIG. 1, the method of the present invention is applied to a network system 1 which comprises the Internet 2, a private network 3 and a hand-held electronic device 4 (such as a hand-held wireless communication device like a mobile phone or personal digital assistant etc.) wherein the private network 3 comprises at least a computer with network interface (such as a personal computer or server etc.) and at least two network terminal devices (such as web camera, IP phone, web disk or network printer etc.). In one preferred embodiment of the present invention, the private network 3 is exemplified with a computer 31 with network interface, a first network terminal device 32 (such as a web camera) and a second network terminal device 33 (such as a web disk), however, the private networks 3 is not limited to the case stated above and may comprise more than two network terminal devices in other embodiments of the present invention. A Fat UA 311 is installed on the computer 31, and the computer 31 and each of the network terminal devices 32 and 33 may connect to the Internet 2 through a network connection device 34 (such a router or switch). The hand-held electronic device 4 is installed with a Thin UA 411 which is capable of processing simple commands and establishing network connection to receive, transfer and process the commands, and enable the hand-held electronic device 4 to connect with the computer 31 and send a control command to the computer 31 through the Internet 2. After the control command is received, the Fat UA 311 encapsulates the control command in each of two SIP packets and sends them to the first network terminal device 32 and second network device 33 respectively. After said packets are received, each of said network terminal devices 32 and 33 will send SIP packets for connection request and connection response to the other so as to automatically establish a tunnel between them, retrieve the control commands encapsulated in the SIP packets, and proceed mutual data access according to the control command. Please refer to FIG. 2, in said embodiment, when a user using the Thin UA 411 of the hand-held electronic device 4 to connect the first network terminal device 32 and second network terminal device 33 of the private network 3, the network system 1 follows the steps of:

(200) the Thin UA 411 sending a control command to the computer 31 through the Internet 2 according to the instructions of the user;

(201) after the control command is received, the FAT UA 311 of the computer 31 encapsulating the control command in each of the first and second SIP packets and sending said packets to the first network terminal device 32 and second network terminal device 33 respectively wherein the first SIP packet is sent to the first network terminal device 32 instructing the first network terminal device 32 to send a SIP packet for connection request to the second network terminal device 33 while the second SIP packet is sent to the second network terminal device 33 instructing the second network terminal device 33 to send a SIP packet for connection response to the first network terminal device 32;

(202) the first network terminal device 32 sending a SIP packet for connection request to the second network terminal device 33 after the first SIP packet is received while the second network terminal device 33 sending a SIP packet for connection response to the first network terminal device 32 after the second SIP packet is received thus automatically establishing a tunnel between the first network terminal device 32 and second network terminal device 33; and

(203) the first network terminal device 32 and second network terminal device 33 retrieving the control commands encapsulated in the first SIP packet and second SIP packet respectively, and proceeding RTP streaming transfer for mutual data access through the tunnel according to the control command.

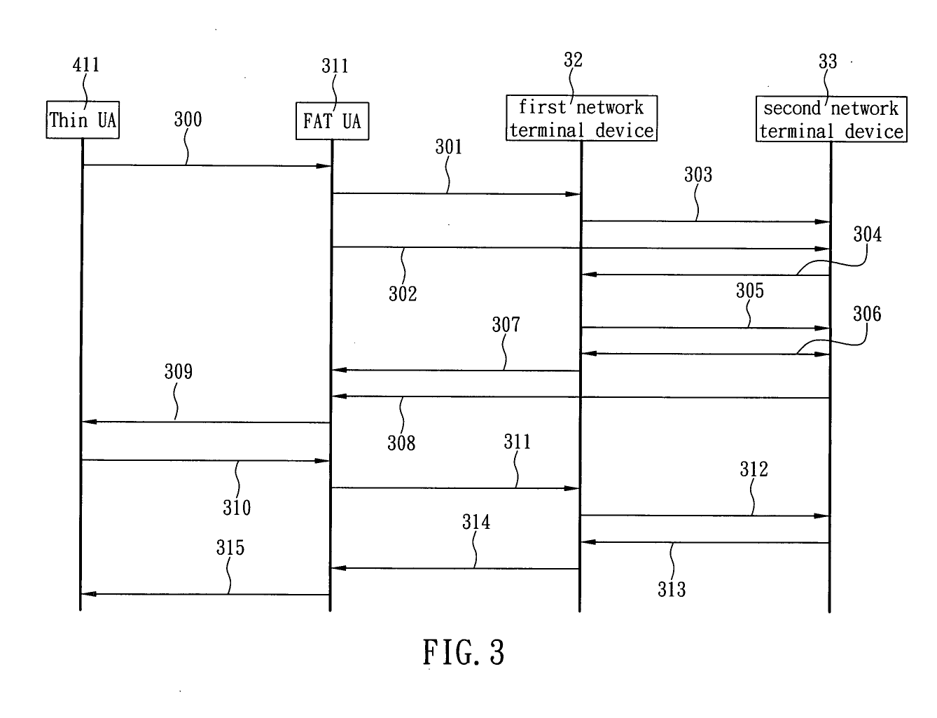

Please refer to FIG. 1 again, in said embodiment, it is assumed that the first network terminal device 32 is a web camera and second network terminal device 33 is a web disk respectively and both connected with the computer 31, and the hand-held electronic device 4 is connected with the computer 31 through the Internet 2. When a user uses the Thin UA 411 installed on the hand-held electronic device 4 to connect the first network terminal device 32 and second network terminal device 33 of the private network 3, the network system 1 will automatically establish a tunnel between the first network terminal device 32 and second network terminal device 33 by following the above steps to enable RTP streaming transfer between said network terminal devices 32 and 33 through the tunnel. Please refer to FIGS. 1 and 3, the sequences of establishing the tunnel are as follows:

(300) the Thin UA 411 installed on the hand-held electronic device 4 sending a control command to the computer 31 through the Internet 2, and after the control command is received, the Fat UA 311 installed on the computer 31 encapsulating the control command in a first SIP packet and a second SIP packet respectively;

(301) the Fat UA 311 of the computer 31 sending the first SIP packet to the first network terminal device 32 instructing the first network terminal device 32 to send a SIP packet for connection request to the second network terminal device 33;

(302) the Fat UA 311 of the computer 31 sending the second SIP packet to the second network terminal device 33 instructing the second network terminal device 33 to send a SIP packet for connection response to the first network terminal device 32;

(303) the first network terminal device 32 sending a SIP packet for connection request to the second network terminal device 33;

(304) the second network terminal device 33 sending a SIP packet for connection response to the first network terminal device 32;

(305) after the SIP packets for connection request and connection response are sent and received, the first network terminal device 32 sending a SIP packet for confirmation to the second network terminal device 33 thus automatically establishing a tunnel between the first network terminal device 32 and second network terminal device 33;

(306) the first network terminal device 32 and second network terminal device 33 retrieving the control commands encapsulated in the first SIP packet and second SIP packet respectively, and proceeding RTP streaming transfer according to the control commands wherein in the case that said control command instructs the first network terminal device (i.e. the web camera) to take photographs of its surrounding and transmit the real-time photographs to the second network terminal device 33 (i.e. the web disk) for storage, the first network terminal device 32 will carry out above operations according to the control command after the tunnel is established automatically;

(307) after the operations instructed by the control command are completed, the first network terminal device 32 sending a third SIP packet to the computer 31;

(308) after the operations instructed by the control command are completed, the second network terminal device 33 sending a fourth SIP packet to the computer 31;

(309) after the third or fourth SIP packet is received, the Fat UA 311 of the computer 31 retrieving a completion command encapsulated in the third or fourth packet and sending it to the hand-held electronic device 4 through the Internet 2;

(310) after the completion command is received, the Thin UA 411 of the hand-held electronic device 4 sending a termination command to the computer 31 through the Internet 2;

(311) after the termination command is received, the Fat UA 311 of the computer 31 encapsulating the termination command in a fifth SIP packet and sending it to the first network terminal device 32 instructing the first network terminal device 32 to send a SIP packet for disconnection to the second network terminal device 33;

(312) the first network terminal device 32 sending a SIP packet for disconnection to the second network terminal device 33;

(313) after the SIP packet for disconnection is received, the second network terminal device 33 sending a SIP packet for confirmation of disconnection to the first network terminal device 32 thus the network terminal devices 32 and 33 are disconnected and return to their original state;

(314) the first network terminal device 32 encapsulating information of disconnection in a sixth SIP packet and sending it to the computer 31; and

(315) after the sixth SIP packet is received, the Fat UA 311 of the computer 31 retrieving the information of disconnection encapsulated in the sixth SIP packet and sending it to the hand-held electronic device 4 through the Internet 2 thus the Thin UA 411 of the hand-held electronic device 4 will be notified that data access between the first network terminal device 32 and second network terminal device 33 has been completed and both devices have returned to their original state. As we can see, in present invention, only the Thin UA 411 is installed on the hand-held electronic device. Due to that the APIs of the Thin UA 411 are only capable of processing simple commands and establishing network connection thus occupy a small memory space (10 to 100 Kbytes) and consume little CPU resource of the hand-held electronic device, the Thin UA 411 may easily be installed on a hand-held wireless communication device like a mobile phone or personal digital assistant for automatic discovery and control of two network terminal devices connected with said computer and enabling said network terminal devices to automatically establish a tunnel between them and proceed mutual data access according to the control command sent by the-hand-held wireless communication device.

While the invention herein disclosed has been described by means of specific embodiments, numerous modifications and variations could be made thereto by those skilled in the art without departing from the scope and spirit of the invention set forth in the claims.

What is claimed is:

1. A method of connecting network terminal devices of a private network by using a hand-held electronic device applied to a network system which comprises a private network, a hand-held electronic device and the Internet wherein said private network comprises at least a computer with network interface and at least two network terminal devices which all connect to the Internet through a network connection device, and said computer is installed a Fat User Agent (Fat UA) while said hand-held electronic device is installed a Thin User Agent (Thin UA) which is capable of processing simple commands and establishing network connection to handle receipt, transfer and processing of commands and enable said hand-held electronic device to connect with said computer through the Internet, comprising:
said Thin UA sending a control command to said computer;
after said control command is received, said Fat UA encapsulating said control command in a first Session Initiation Protocol (SIP) packet and a second SIP packet respectively wherein said first SIP packet is sent to said first network terminal device instructing it to send a SIP packet for connection request to said second network terminal device while said second SIP packet is sent to said second network terminal device instructing it to send a SIP packet for connection response to said first network terminal device;
said first network terminal device sending said SIP packet for connection request to said second network terminal device after said first SIP packet is received while said second network terminal device sending said SIP packet for connection response to said first network terminal device after said second SIP packet is received thus automatically establishing a tunnel between said first network terminal device and said second network terminal device; and
said first network terminal device and said second network terminal device retrieving said control command encapsulated in said first SIP packet and said second SIP packet respectively and proceeding RTP streaming transfer for data access through said tunnel according to said control command.

2. A method of connecting network terminal devices of a private network by using a hand-held electronic device of claim 1, wherein said hand-held electronic device is a hand-held wireless communication device.

3. A method of connecting network terminal devices of a private network by using a hand-held electronic device of claim 2, wherein said hand-held wireless communication device is a mobile phone.

4. A method of connecting network terminal devices of a private network by using a hand-held electronic device of claim 2, wherein said hand-held wireless communication device is a personal digital assistant.
